(19) United States
(12) Patent Application Publication
(10) Pub. No.: US 2025/0231525 A1
(43) Pub. Date: Jul. 17, 2025

(54) IMAGE FORMING APPARATUS

(71) Applicant: KYOCERA Document Solutions Inc., Osaka (JP)

(72) Inventor: Dat The Hoang, Osaka (JP)

(73) Assignee: KYOCERA Document Solutions Inc., Osaka (JP)

(21) Appl. No.: 19/014,156

(22) Filed: Jan. 8, 2025

(30) Foreign Application Priority Data
Jan. 12, 2024 (JP) 2024-003195

(51) Int. Cl. G03G 21/18

(52) U.S. Cl. CPC G03G 21/185

(57) ABSTRACT

An image forming apparatus includes a process unit pulled out from an apparatus main body along a pull-out direction. The process unit includes a pair of side plates, a plurality of developing devices, a lock member, and a biasing member. The side plates face each other in a direction crossing the pull-out direction. The developing devices are arranged along the pull-out direction and attached to the side plates detachably. The lock member is provided for each developing device and movable between a lock position and an unlock position. The biasing member biases the lock member to the lock position. The apparatus main body includes a guide part. As the process unit is pulled out, one of the lock members is guided by the guide part and moved to the lock position or the unlock position such that the developing device corresponding to the lock member is locked or unlocked.

### INCORPORATION BY REFERENCE

This application is based on and claims the benefit of priority from Japanese patent application No. 2024-003195 filed on Jan. 12, 2024, which is incorporated by reference in its entirety.

### BACKGROUND

The present disclosure relates to an image forming apparatus provided with a process unit which can be pulled out from an apparatus main body.

The tandem color image forming apparatus is provided with a process unit which can be pulled out from the apparatus main body. The process unit is provided with four developing devices arranged in parallel along a pull-out direction and housed in a frame. The developing device is locked to the side plate of the frame by a locking mechanism.

The locking mechanism includes, for example, a lock member supported by the frame movably in the front-and-rear direction. When the developing device is housed in the frame from the upper side, the lock member is pushed downward by the developing device to be retracted, and then the lock member is moved forward to be engaged with the developing device.

In such an image forming apparatus, when the process unit is pulled out from the apparatus main body, the center of gravity moves to the pulled-out process unit, so that the image forming apparatus is in an unstable state. In addition, at a time of replacement of the developing device, the developing device is detached after the process unit is pulled out from the apparatus main body, and then a new developing device is attached. At this time, since the developing device is pushed downward to retract the lock member, a downward force is applied to the process unit. Then, the state of the image forming apparatus becomes more unstable.

### SUMMARY

An image forming apparatus according to the present disclosure includes a process unit which is pulled out from an apparatus main body along a predetermined pull-out direction. The process unit includes a pair of side plates, a plurality of developing devices, a lock member, and a biasing member. The side plates face each other in a left-and-right direction crossing the pull-out direction. The developing devices are arranged side by side along the pull-out direction and attached to the side plates detachably. The lock member is provided for each of the developing devices and movable along the left-and-right direction between a lock position protruding into the apparatus main body through the side plate and an unlock position separating from the side plate to an outside of the apparatus main body. The biasing member biases the lock member to the lock position. The apparatus main body includes a guide part. The guide part is provided so as to protrude to a direction far from the developing device in the left-and-right direction and guides one of the lock members from the lock position to the unlock position with a pull-out operation of the process unit. As the process unit is pulled out, one of the lock members is guided by the guide part and moved to the lock position or the unlock position such that the developing device corresponding to the lock member is locked or unlocked to the side plate.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a side view schematically showing an internal configuration of an image forming apparatus according to one embodiment of the present disclosure.

FIG. 2 is a perspective view schematically showing a process unit housed in an apparatus main body, in the image forming apparatus according to the embodiment of the present disclosure.

FIG. 3 is a disassembled perspective view showing a locking mechanism, in the image forming apparatus according to the embodiment of the present disclosure.

FIG. 4 is a cross-sectional perspective view showing an opening and a cylindrical part of a right side plate, in the image forming apparatus according to the embodiment of the present disclosure.

FIG. 5 is a cross-sectional view showing the locking mechanism (in a state in which a lock member is moved to a lock position), in the image forming apparatus according to the embodiment of the present disclosure.

FIG. 6A is a perspective view showing a lock lever of the lock member, in the image forming apparatus according to the embodiment of the present disclosure.

FIG. 6B is a cross-sectional view showing a cap of the lock member, in the image forming apparatus according to the embodiment of the present disclosure.

FIG. 6C is a front view showing the cap of the lock member, in the image forming apparatus according to the embodiment of the present disclosure.

FIG. 7A to FIG. 7E are cross-sectional perspective views explaining a process of assembling the lock member to the right side plate, in the image forming apparatus according to the embodiment of the present disclosure.

FIG. 8 is a plan view showing a guide part provided in the right side plate, in the image forming apparatus according to the embodiment of the present disclosure.

FIG. 9 is a perspective view showing the process unit pulled out of the apparatus main body, in an image forming apparatus according to an embodiment of the present disclosure.

FIG. 10 is a cross-sectional view showing the locking mechanism (a state in which the lock member is moved to an unlock position), in the image forming apparatus according to the embodiment of the present disclosure.

FIG. 11A is a perspective view showing a release lever in a state where a front cover is closed, in the image forming apparatus according to the embodiment of the present disclosure.

FIG. 11B is a cross-sectional view (viewed from the upper side) showing the lock member in the state where the front cover is closed, in the image forming apparatus according to the embodiment of the present disclosure.

FIG. 12A is a perspective view showing the release lever in a state where the front cover is opened, in the image forming apparatus according to the embodiment of the present disclosure.

FIG. 12B is a cross-sectional view (viewed from the upper side) showing the lock member in the state where the front cover is opened, in the image forming apparatus according to the embodiment of the present disclosure.

### DETAILED DESCRIPTION

Hereinafter, with reference to the attached drawings, an image forming apparatus according to one embodiment of the present disclosure will be described.

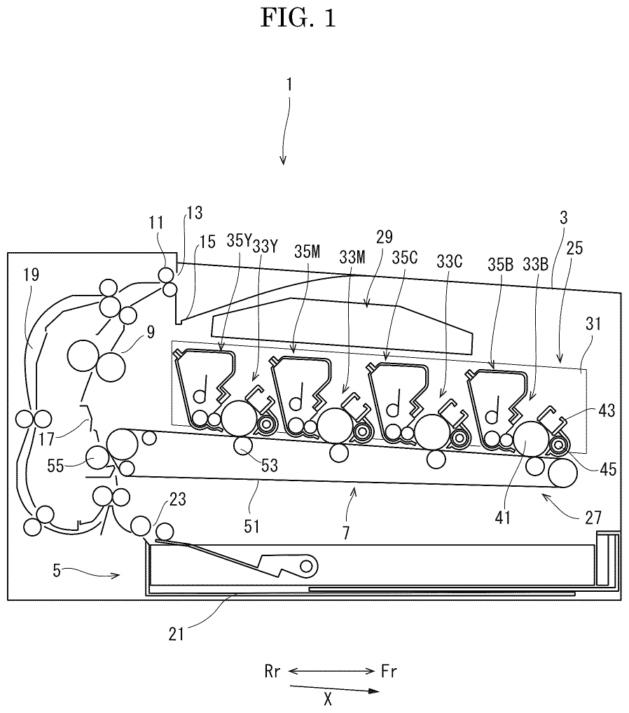

With reference to FIG. 1, an overall configuration of the image forming apparatus 1 will be described. FIG. 1 is a side view schematically showing an internal configuration of the image forming apparatus 1. Up, Lo, Fr, Rr, L, and R in each of the figures indicate the upper side, the lower side, the front side, the rear side, the left side, and the right side of the image forming apparatus 1, respectively.

Inside an apparatus main body 3 of the image forming apparatus 1, a sheet feeding part 5, an electrophotographic image forming part 7, a fixing device 9, and a discharge device 11 are housed. In the top plate of the apparatus main body 3, a discharge port 13 and a discharge tray 15 disposed in front of the discharge port 13 are provided. Further, inside the apparatus main body 3, a main conveyance path 17 and an inversion conveyance path 19 are provided.

The sheet feeding part 5 is disposed in the lower portion of the inside of the apparatus main body 4, and includes a sheet feeding cassette 21 in which sheets are stored, and a sheet feeding device 23 which feeds the sheet from the sheet feeding cassette 21.

The image forming part 7 is disposed above the sheet feeding part 5, and includes a process unit 25, an intermediate transfer device 27, and an exposure device 29.

The process unit 25 includes a frame 31, four photosensitive drum units 33Y, 33M, 33C, and 33B (collectively referred to as a photosensitive drum unit 33) corresponding to toner of four colors (yellow, magenta, cyan, and black) and developing devices 35Y, 35M, 35C, and 35B (collectively referred to as a developing device 35) which are supported by the frame 31.

The four photosensitive drum units 33Y, 33M, 33C and 33B are arranged side by side in the front-and-rear direction. The photosensitive drum unit 33 includes a photosensitive drum 41 on which an electrostatic latent image is formed, a charger 43 which charges the photosensitive drum 41, and a cleaning roller 45 which removes the toner remaining on the photosensitive drum 41. The photosensitive drum 41 is rotatable in a counterclockwise direction in FIG. 1 around a rotational axis. The charger 43 and the cleaning roller 45 arranged are around the photosensitive drum 41 along the rotational direction of the photosensitive drum 41.

The four developing devices 35Y, 35M, 35C, and 35B are arranged on the rear side of the corresponding four photosensitive drum units 33Y, 33M, 33C, and 33B side by side in the front-and-rear direction. The developing device 35 develops the electrostatic latent image formed on the photosensitive drum 41 by, for example, a one-component developing method with the toner.

At a time of maintenance or replacement of parts, the process unit 25 can be pulled out from the apparatus main body 3 in the front-and-rear direction through an opening (not shown) formed in the front plate of the apparatus main body 3. The process unit 25 will be described later.

The intermediate transfer device 27 is disposed below the process unit 25, and includes an endless intermediate transfer belt 51, four primary transfer rollers 53 corresponding to the four photosensitive drum units 33Y, 33M, 33C, and 33B, and a secondary transfer roller 55. The intermediate transfer belt 51 is wound around a driving roller and a driven roller which are spaced apart from each other in the front-and-rear direction and a tension roller, and travels in the clockwise direction of FIG. 1. The upper traveling track of the intermediate transfer belt 51 is slightly inclined downward from the rear toward the front (in an example, the inclination angle is 3 degrees with respect to the horizontal). With this configuration, a length of the image forming apparatus 1 in the front-and-rear direction can be shortened. The process unit 25 can be pulled out of the apparatus main body 3 along the pull-out direction X along the inclined direction.

The four primary transfer rollers 53 are arranged side by side in the front-and-rear direction in the hollow space of the intermediate transfer belt 51. The four primary transfer rollers 53 face the photosensitive drums 41 of the four photosensitive drum units 33 of the process unit 25 across the intermediate transfer belt 51, and form primary transfer nips between the intermediate transfer belt 51 and the photosensitive drums 41. The secondary transfer roller 55 faces the driving roller across the intermediate transfer belt 51. A secondary transfer nip is formed between the intermediate transfer belt 51 and the secondary transfer roller 55.

The exposure device 29 is arranged above the process unit 25, and exposes the photosensitive drums 41 based on image data. More specifically, the exposure device 29 is disposed above the process unit 25 on the rear side of the photosensitive drum unit 33B and the developing device 35B which are disposed at the foremost. A space is formed above the photosensitive drum unit 33B and the developing device 35B which are disposed at the foremost.

The fixing device 9 is disposed above the secondary transfer nip. The fixing device 9 includes a pressure roller and a heating roller, and a fixing nip is formed between both rollers. The discharge device 11 is disposed above the fixing device 9, and inside the discharge port 13.

The main conveyance path 17 is formed from the sheet feeding device 23 of the sheet feeding part 5 to the discharge device 11 through the secondary transfer nip and the fixing nip. The inversion conveyance path 19 is branched from the main conveyance path 17 on the downstream side of the fixing device 9 in the sheet conveyance direction, merged and with the main conveyance path 17 on the upstream side of the secondary transfer nip.

Next, the image forming operation will be briefly described. In the image forming part 7, the photosensitive drum 41 of each photosensitive drum unit 33 of the process unit 25 is charged by the charger 43. Thereafter, the photosensitive drum 41 is exposed by the exposure device 29 to form an electrostatic latent image based on the image data. The electrostatic latent image is developed into a toner image by the developer carried on a developing roller of the developing device 35. The toner image is transferred from the photosensitive drums 41 to the intermediate transfer belt 51 in the primary transfer nips. Thus, a full-color toner image is formed on the intermediate transfer belt 51.

On the other hand, in the sheet feeding part 5, the sheets are fed from the sheet feeding cassette 21 to the main conveyance path 17 by the sheet feeding device 23. The sheet is conveyed to the secondary transfer nip, and the toner image formed on the intermediate transfer belt 51 is transferred to one surface of the sheet at the secondary transfer nip. The sheet is conveyed to the fixing device 9 along the main conveyance path 17, and the toner image is fixed to the sheet at the fixing nip. The sheet is further conveyed to the discharge device 11, and discharged to the discharge tray 15 through the discharge port 13 by the discharge device 11.

In the case of duplex printing, the sheet on which the toner image is fixed on one surface is conveyed from the main conveyance path 17 to the inversion conveyance path 19, and the toner image is transferred to the other surface of the sheet at the secondary transfer nip. Thereafter, after the toner image is fixed to the other surface of the sheet by the fixing device 9, the sheet is conveyed to the discharge device 11, and discharged to the discharge tray 15 through the discharge port 13 by the discharge device 11.

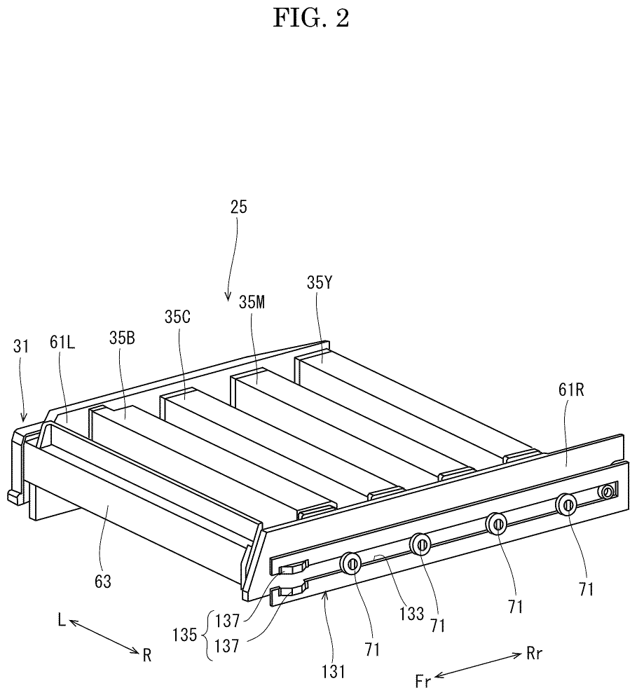

Next, the process unit 25 will be further described with reference to FIG. 2. FIG. 2 is a perspective view showing the process unit 25. As described above, the process unit 25 includes the frame 31, the four photosensitive drum units 33Y, 33M, 33C, and 33B and the four developing devices 35Y, 35M, 35C, and 35B supported by the frame 31. The photosensitive drum unit 33 is not shown in FIG. 2.

First, the frame 31 will be described. The frame 31 includes left and right side plates 61L, 61R facing in the left-and-right direction intersecting the pull-out direction X (see FIG. 1) of the process unit 25, and a front cover 63 disposed between the front edges of the left and right side plates 61L, 61R. The left and right lower corners of the front cover 63 are rotatably supported by the left and right side plates 61L, 61R. Thus, the front cover 63 can be rotated forward from an upright posture (see FIG. 2) standing between the front edges of the right and left side plates 61L, 61R.

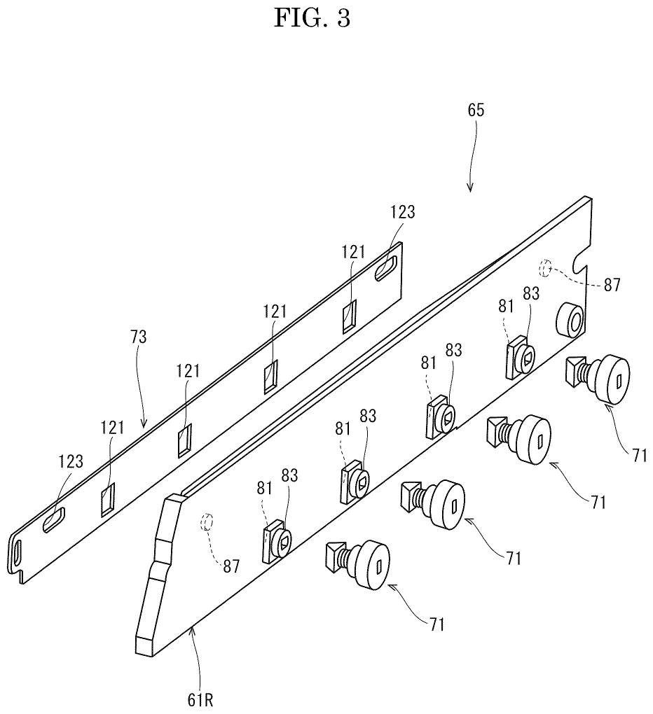

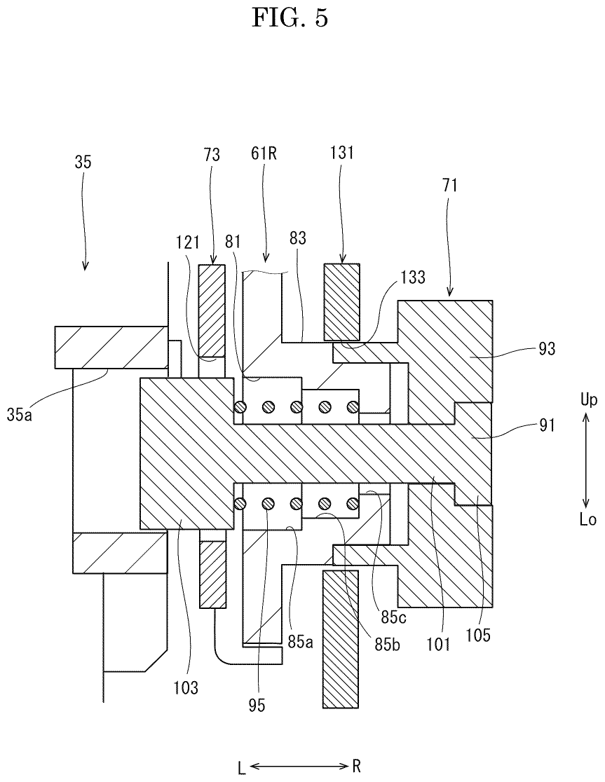

The left side plate 61L is provided with a positioning portion (not shown) on which the left end portions of the developing devices 35 are placed and positioned. The right side plate 61R is provided with a locking mechanism 65 (not shown in FIG. 2, see FIG. 3 and the others) which locks the right end portions of the developing devices 35 detachably. An engagement opening 35a (not shown in FIG. 2, see FIG. 5 and the others) is formed at the right end portion of the developing device 35. The locking mechanism 65 is engaged with the engagement opening 35a so that the right end portions of the developing device 35 is locked to the right side plate 61R detachably. By locking the right end portion of the developing device 35 to the right side plate 61R in this manner, the developing device 35 is locked to the frame 31.

Next, the locking mechanism 65 will be described with reference to FIG. 3. FIG. 3 is a perspective view showing the locking mechanism 65. The locking mechanism 65 is provided with four lock members 71 and a release lever 73. The four lock member 71 is provided for each developing device 35 and supported by the right side plate 61R movably in the left-and-right direction (the direction intersecting with the pull-out direction X). The release lever 73 is supported by the right side plate 61R movably in the front-and-rear direction along the inner surface of the right side plate 61R.

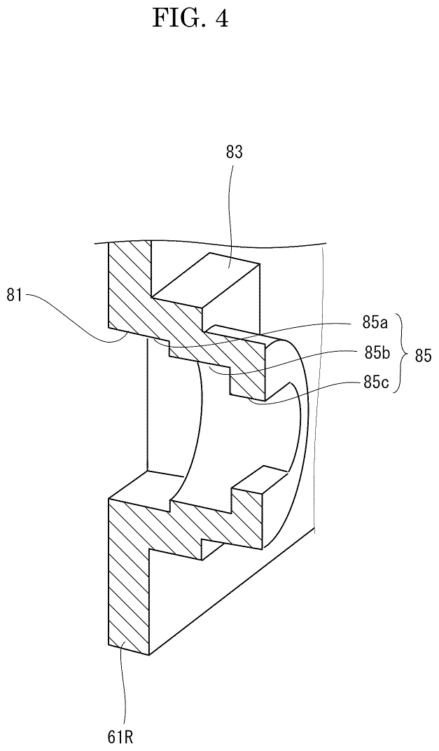

First, the right side plate 61R will be described with reference to FIG. 3 and FIG. 4. FIG. 4 is a cross-sectional perspective view showing an opening 81 and a cylindrical part 83 provided on the right side plate 61R. The right side plate 61R has four openings 81 each having a square cross section and corresponding to the four developing devices 35Y, 35M, 35C and 35B.

As shown in FIG. 4, the cylindrical part 83 is formed along the periphery of the opening 81 on the outer surface of side plate the right 61R. The cylindrical part 83 has a through-holes 85 extending in the left-and-right direction. The through-hole 85 has a lower step portion 85a, a middle step portion 85b, and an upper step portion 85c in order from the side of the opening 81. The lower step portion 85a has the same square cross-sectional shape as the opening 81. The middle step portion 85b has a substantially vertically elongated rectangular cross-sectional shape (rounded rectangular shape). A longer side length of the cross section of the middle step portion 85b is shorter than a length of one side of the cross section of the lower step portion 85a. The upper step portion 85c has a substantially horizontally elongated rectangular cross-sectional shape (rounded rectangular shape) intersecting at right angles with the middle step portion 85b.

As shown in FIG. 3, front and rear guide projections 87 are formed on the inner surface of the right side plate 61R at the same height above the four openings 81.

Next, the lock member 71 will be described with reference to FIG. 5. FIG. 5 is a cross-sectional view showing the lock member 71. The lock member 71 includes a lock lever 91 engageable with the engagement opening 35a of the developing device 35, a cap 93 integrally provided with the lock lever 91, and a coil spring 95 fitted around the lock lever 91.

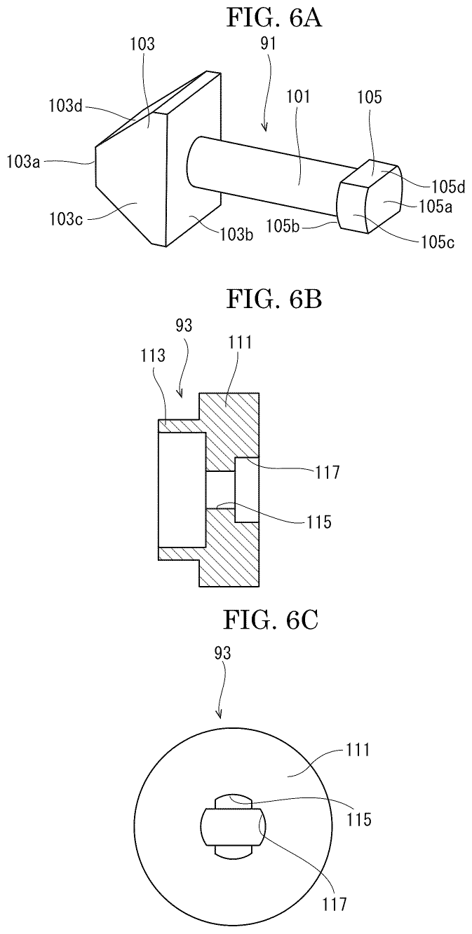

First, the lock lever 91 will be described with reference to FIG. 6A. FIG. 6A is a perspective view showing the lock lever 91. The lock lever 91 has a cylindrical shaft 101, an engagement portion 103 provided at one end portion of the shaft 101 and engageable with the engagement opening 35a, and a fixing portion 105 provided at the other end portion of the shaft 101 and coupled to the cap 93.

The engagement portion 103 has a pyramidal trapezoidal shape, and has a rectangular top surface 103a, a rectangular bottom surface 103b parallel to the top surface 103a and having a larger area than the top surface 103a, a pair of parallel trapezoidal side surfaces 103c, and a pair of inclined side surfaces 103d inclined from the bottom surface 103b toward the top surface 103a. One end portion of the shaft 101 is fixed to the center of the bottom surface 103b.

The fixing portion 105 has a substantially rectangular shape (rounded rectangular shape), and has a top surface 105a and a bottom surface 105b which are parallel to each other, a pair of arc-shaped side surfaces 105c, and a pair of parallel rectangular side surfaces 105d. A longer side length of the cross section of the fixing portion 105 is longer than a diameter of the shaft 101, and a shorter side length of the cross section of the fixing portion 105 is equal to the diameter of the shaft 101. The other end portion of the shaft 101 is fixed to the center of the bottom surface 105b. In the circumferential direction of the shaft 101, the trapezoidal side surfaces 103c of the engagement portion 103 and the arc-shaped side surfaces 105c of the fixing portion 105 are arranged in the same direction, and the inclined side surfaces 103d of the engagement portion and the rectangular side surfaces 105d of the fixing portion 105 are arranged in the same direction.

A longer side length and a shorter side length of the cross section of the fixing portion 105 are equal to a longer side length and a shorter side length of the cross sections of the middle step portion 85b and the upper step portion 85c of the through-hole 85 of the cylindrical part 83 of the right side plate 61R, respectively.

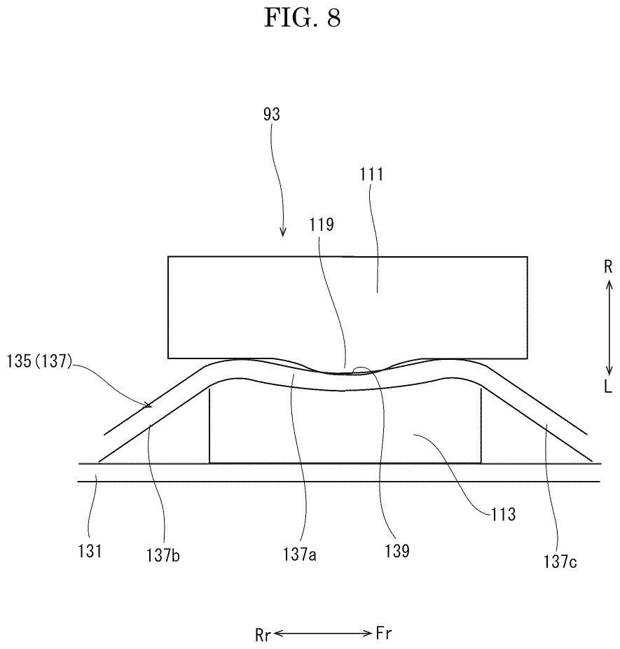

Next, the cap 93 will be described with reference to FIG. 6B and FIG. 6C. FIG. 6B is a cross-sectional view showing the cap 93, and FIG. 6C is a front view showing the cap 93. The cap 93 has a disk portion 111 and a cylindrical portion 113 provided on one end surface of the disk portion 111. A through-hole 115 extending in the axial direction is formed in the center of the disk portion 111. A cross-sectional shape of the through-hole 115 is the same as the cross-sectional shape of the fixing portion 105 of the lock lever 91. Further, a recess 117 intersecting at right angles with the through-hole 115 when viewed in the axial direction is formed on the outer surface of the disk portion 111. A depth of the recess 117 is substantially equal to a height (thickness) of the fixing portion 105. On the inner surface of the disk portion 111, two gentle protrusions 119 (not shown in FIG. 6B and FIG. 6C, see FIG. 8) are formed on a diagonal line. The two protrusions 119 are arranged in the longer side direction of the recess 117.

The cylindrical portion 113 is formed coaxially with the through-hole 115 between the through-ole 115 and the two protrusions 119.

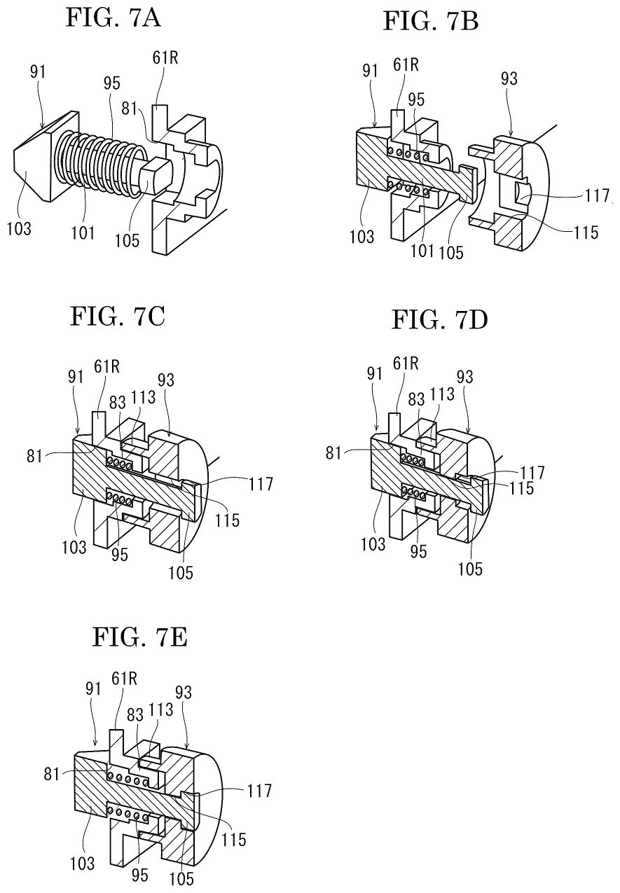

Next, a process of assembling the lock member 71 to the right side plate 61R will be described with reference to FIG. 7A to FIG. 7E. FIG. 7A to FIG. 7E are perspective views showing the lock member 71 and the right side plate 61R. First, as shown in FIG. 7A, the lock lever 91 is held such that the fixing portion 105 is in the horizontally elongated posture (a posture in which the longer side direction is along in the front-and-rear direction), and the coil spring 95 is externally fitted to the shaft 101 from the side of the fixing portion 105. Then, the fixing portion 105 is inserted into the opening 81 of the right side plate 61R from the inside.

As shown in FIG. 7B, the distal end portion of the lock lever 91 (the distal end portion of the shaft 101 and the fixing portion 105) protrudes from the cylindrical part 83 through the through-hole 85 of the cylindrical part 83 from the opening 81. The coil spring 95 is arranged between the bottom surface 103b of the engagement portion 103 of the lock lever 91 and the periphery portion of the through-hole 85 of the cylindrical part 83 of the right side plate 61R. Then, the lock lever 91 is rotated by 90 degrees. As a result, the fixing portion 105 of the lock lever 91 is turned into a vertically elongated posture (a posture in which the longer axis direction is along the upper-and-lower direction). As a result, the lock lever 91 is prevented from coming off the cylindrical part 83. Further, the inclined side surfaces 103d (see FIG. 6A) of the engagement portion 103 are arranged in the front-and-rear direction, and the engagement portion 103 is in a tapered posture toward the inside of the right side plate 61R viewed from the upper side.

Thereafter, the cap 93 is placed on the distal end portion of the lock lever 91 protruding from the cylindrical part 83 of the right side plate 61R. That is, the cap 93 is held such that the through-hole 115 is in a vertically elongated posture (the longer side direction is along the upper-and-lower direction), and the fixing portion 105 of the lock lever 91 is inserted into the through-hole 115.

As shown in FIG. 7C, the cylindrical portion 113 of the cap 93 covers the cylindrical part 83 of the right side plate 61R. Further, the lock lever 91 is pushed into the opening 81 of the right side plate 61R against a biasing force of the coil spring 95. When the lock lever 91 is pushed in until the engagement portion 103 is inserted into the lower step portion 85a (see FIG. 4) of the cylindrical part 83 through the opening 81 of the right side plate 61R, the fixing portion 105 protrudes outward from the cap 93. Thereafter, the cap 93 is rotated by 90 degrees. As a result, as shown in FIG. 7D, the recess 117 of the disk portion 111 of the cap 93 and the fixing portion 105 of the lock lever 91 are in a vertically elongated posture (the longer side direction is along the upper-and-lower direction).

Thereafter, when the pushing force of the lock lever 91 is released, as shown in FIG. 7E, the lock lever 91 is biased toward the inside of the right side plate 61R by the coil spring 95 with respect to the cylindrical part 83 of the right side plate 61R, and the engagement portion 103 of the lock lever 91 protrudes inward from the right side plate 61R. The fixing portion 105 of the lock lever 91 is fitted into the recess 117 of the disk portion 111 of the cap 93. This completes the assembly of the lock member 71 to the right side plate 61R.

Next, the release lever 73 will be described with reference to FIG. 3. The release lever 73 is a plate-like member elongated in the front-and-rear direction, and has four rectangular through-holes 121 that correspond to the four openings 81 of the right side plate 61R. Further, front and rear guide openings 123 are formed above the four through-holes 121. The guide opening 123 has an oval shape long in the front-and-rear direction.

The release lever 73 is supported on the inner surface of the right side plate 61R so as to be movable in the front-and-rear direction. Specifically, the front and rear guide openings 123 of the release lever 73 are inserted into the front and rear guide projections 87 of the right side plate 61R. The front end portion of the release lever 73 is connected to the front cover 63 (see FIG. 2) of the frame 31. When the front cover 63 is closed, the four through-holes 121 are aligned with the four openings 81 of the right side plate 61R in the left-and-right direction. On the other hand, when the front cover 63 is opened, the release lever 73 is guided by the guide projections 87 and moved forward, and the four through-holes 121 are separated from the four openings 81 of the right side plate 61R.

Next, a structure for supporting the process unit 25 on the apparatus main body 3 will be described with reference to FIG. 2. As described above, the process unit 25 can be pulled out forward through the opening formed in the front side plate of the apparatus main body 3. The left and right side plates (not shown) of the apparatus main body 3 includes right and left guide rails 131 (only the right guide rail 131 is shown in FIG. 2) for supporting the process unit 25 movably in the front-and-rear direction. The left guide rail (not shown) has a groove along the front-and-rear direction, which is engageable with a guide portion (not shown) provided on the left side plate 61L of the process unit 25.

As shown in FIG. 2, the right guide rail 131 has a groove 133 along the front-and-rear direction, which is engageable with the four lock members 71 of the process unit 25. A width (height) of the groove 133 is equal to an outer diameter of the cylindrical portion 113 of the cap 93 of the lock member 71, and the cylindrical portion 113 of the cap 93 is engaged with the groove 133. The groove 133 opens at the front edge of the guide rail 131. On the outer surface of the guide rail 131, a guide part 135 is provided at the front end portion of the groove 133.

With reference to FIG. 2 and FIG. 8, the guide part 135 will be described. FIG. 8 is a view showing the guide part 135 viewed from the upper side. The guide part 135 includes upper and lower guide pieces 137 provided above and below the groove 133. As shown in FIG. 8, the upper and lower guide pieces 137 have a substantially trapezoidal shape viewed from the upper-and-lower direction, and each has a top portion 137a, a rear inclined portion 137b inclined rearward from the rear end of the top portion 137a, and a front inclined portion 137c inclined forward from the front end of the top portion 137a. A shallow recess 139 is formed in the center of the top portion 137a. The upper and lower guide pieces 137 are formed, for example, by cutting out a part of the guide rail 131 and working it.

In a state where the process unit 25 is housed in the apparatus main body 3, as shown in FIG. 2, the four lock members 71 (the cylindrical portions 113 of the caps 93) are engaged with the groove 133 on the rear side of the guide part 135.

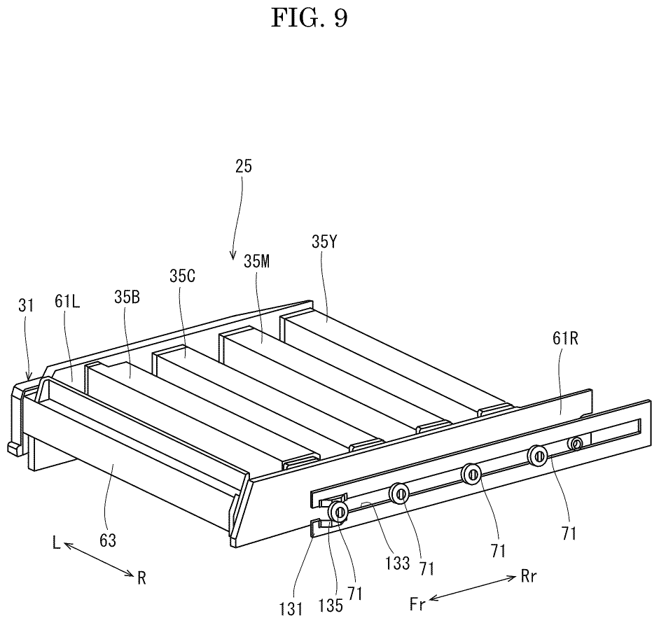

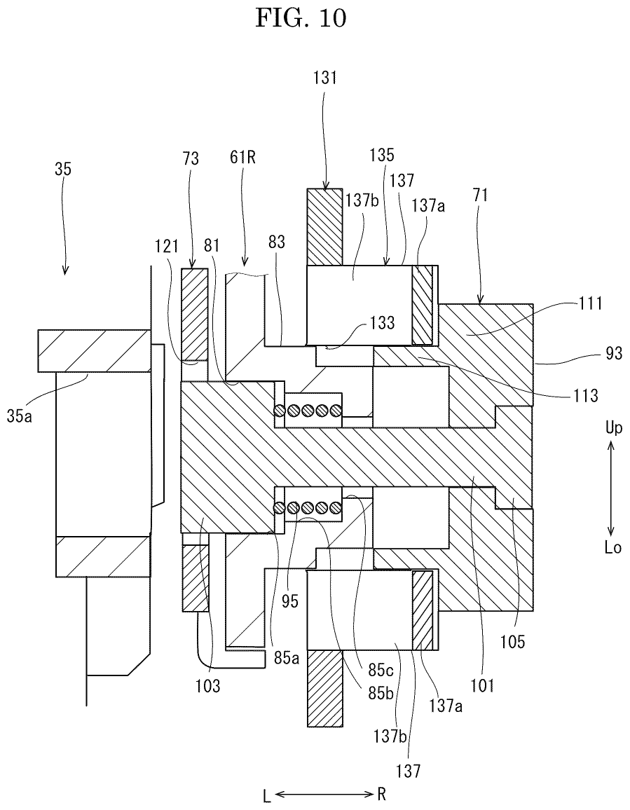

The operation of detaching the developing device 35 from the frame 31 and the operation of attaching the developing device 35 to the frame 31 in the process unit 25 having the above configuration will be described with reference to FIG. 2, FIG. 5, FIG. 8 and the others, and FIG. 9 and FIG. 10. FIG. 9 is a perspective view showing the process unit 25 pulled out from the apparatus main body 3, and FIG. 10 is a sectional view showing the lock member 71 separated from the developing device 35.

In the process unit 25, as shown in FIG. 2, the four developing devices 35 are locked to the right side plate 61R via the lock members 71. More specifically, as shown in FIG. 5, the lock lever 91 of the lock member 71 is biased by the coil spring 95, and the engagement portion 103 protrudes inward (toward the developing device 35) from the right side plate 61R, passes through the through-hole 121 of the release lever 73, and is inserted into the engagement opening 35a of the developing device 35. Thus, the developing device 35 is locked to the right side plate 61R. The position in which the engagement portion 103 protrudes inward from the right side plate 61R is referred to as a lock position of the lock lever 91.

At the time of maintenance or replacement of parts, the process unit 25 is pulled out forward along right and left guide rails 131 through the opening in the front side plate of the apparatus main body 3. At this time, the cylindrical portions 113 of the caps 93 of the four lock members 71 of the process unit 25 are moved forward in the groove 133 of the guide rail 131.

Eventually, as shown in FIG. 9, the cylindrical portion 113 of the cap 93 of the lock member 71 corresponding to the developing device 35B disposed at the foremost reaches the guide part 135 of the groove 133. Then, the disk portion 111 of the cap 93 of the lock member 71 rides on the rear inclined portions 137b (see FIG. 8) of the upper and lower guide pieces 137 of the guide part 135. Thereafter, when the process unit 25 is further pulled out forward, as shown in FIG. 8 and FIG. 10, the disk portion 111 of the cap 93 of the lock member 71 rides up from the rear inclined portions 137b of the upper and lower guide pieces 137 to the top portions 137a. As a result, the cap 93 is moved outward (away from the developing device 35). Then, as shown in FIG. 10, the lock lever 91 integrally fixed to the cap 93 is moved outward, and the engagement portion 103 is separated from the engagement opening 35a of the developing device 35, passes through the through-hole 121 of the release lever 73 and the opening 81 of the right side plate 61R, and is housed in the lower step portion 85a of the through-hole 85 of the cylindrical part 83.

Thereafter, by lifting the developing device 35B corresponding to the lock member 71 disposed at the foremost, the developing device 35 can be detached from the frame 31. The position where the engagement portion 103 of the lock lever 91 is housed in the through-hole 85 of the cylindrical part 83 of the right side plate 61R is referred to as an unlock position of the lock lever 91. Since the exposure device 29 is not disposed above the guide part 135 and a predetermined space is formed above the guide part 135, the developing device 35 is lifted into this space and then pulled out forward through the opening in the front plate of the apparatus main body 3.

Further, as shown in FIG. 8, since the two protrusions 119 provided on the disk portion 111 of the cap 93 enter the recesses 139 formed on the top portions 137a of the upper and lower guide pieces 137, the movement of the process unit 25 when the developing device 35 is detached is restricted.

When the developing device 35 other than the developing device 35B disposed at the foremost is detached, the process unit 25 may be pulled out until the lock member 71 corresponding to the developing device 35 reaches the guide part 135.

On the other hand, when the detached developing device 35 is attached on the frame 31, the process unit 25 is pulled out from the apparatus main body 3 until the lock member 71 corresponding to the developing device 35 reaches the guide part 135. Thus, as described above, the lock member 71 is guided by the guide part 135 and moved to the unlock position (see FIG. 10). Thereafter, the developing device 35 is housed in the frame 31 from the upper side.

The process unit 25 is pushed rearward until the lock member 71 is separated from the guide part 135. Then, the lock member 71 is separated from the guide part 135, the lock lever 91 of the lock member 71 is biased by the coil spring 95, and the lock member 71 is moved to the lock position. As described above, the coil spring 95 is an example of the biasing member which biases the lock member 71 to the lock position according to the present disclosure. As a result, the engagement portion 103 of the lock lever 91 is inserted into the engagement opening 35a of the developing device 35 (see FIG. 5). Thus, the developing device 35 is locked to the frame 31.

As described above, according to the present disclosure, the developing device 35 can be locked and unlocked to the side plate 61 by moving the lock member 71 in the left-and-fight direction (the direction intersecting with the pull-out direction X) in accordance with the pull-out operation of the process unit 25. That is, when the developing device 35 is attached to the frame 31 or detached from the frame 31, it is not necessary to apply a load along the upper-and-lower direction to the process unit 25. Therefore, even in the image forming apparatus in an unstable state due to the shift of the center of gravity when the process unit 25 is pulled out, the developing device 35 can be stably attached to the frame 31 or detached from the frame 31.

Further, since the lock member is 71 automatically moved between the lock position and the unlock position by the pull-out operation of the process unit 25, it is not necessary to perform a special operation when the developing device 35 is locked or unlocked.

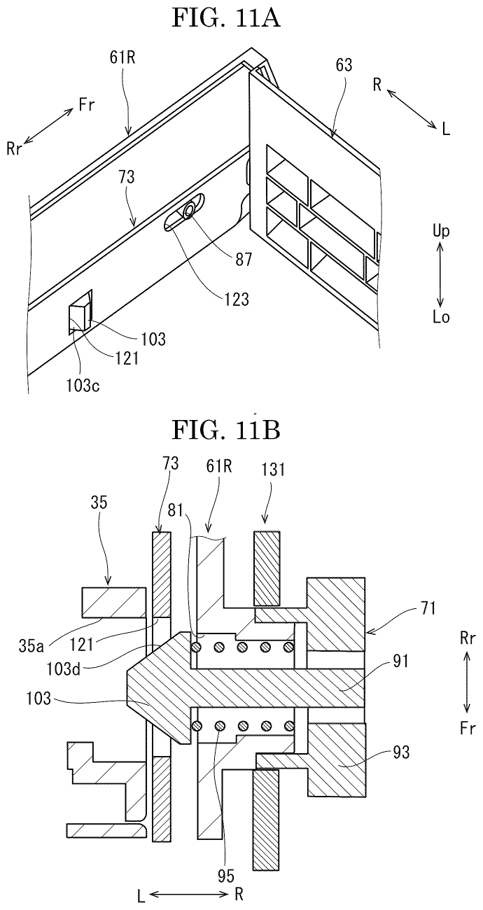

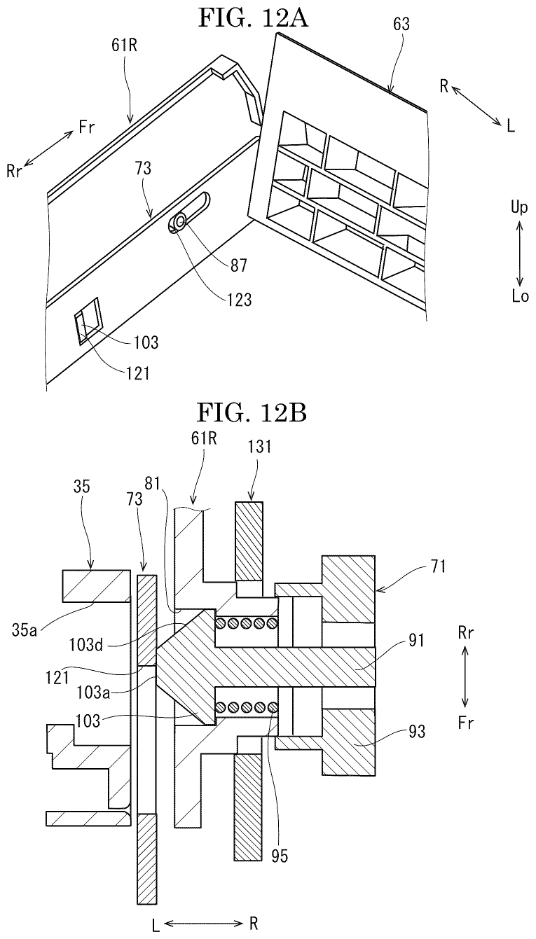

Next, the operation of detaching all of the four developing devices 35 from the frame 31 will be described with reference to FIG. 11A to FIG. 12B. FIG. 11A and FIG. 11B show the release lever 73 and the lock member 71 in a state where the front cover 63 is closed, and FIG. 12A and FIG. 12B show the release lever 73 and the lock member 71 in a state where the front cover 63 is opened. FIG. 11B and FIG. 12B are views of the lock member 71 as viewed from the upper side.

When all the four developing devices 35 are detached from the frame 31, the process unit 25 is first pulled out of the apparatus main body 3. At this time, it is not necessary to position any of the lock members 71 to the guide part 135, and the process unit 25 is pulled out to a position where the developing device 35Y disposed at the rearmost can be detached.

In this state, as shown in FIG. 11A, the front cover 63 is closed. As shown in FIG. 11B, the lock member 71 is moved to the lock position. That is, the engagement portion 103 of the lock lever 91 of the lock member 71 protrudes inward from the through-hole 121 of the release lever 73, and is inserted into the engagement opening 35a of the developing device 35Y (see also FIG. 11A). As shown in FIG. 11B, the engagement portion 103 is in a posture tapering inward when viewed from the upper side, that is, a posture in which the inclined side surfaces 103d are arranged in the front-and-rear direction.

Thereafter, as shown in FIG. 12A, the front cover 63 is opened (rotated forward). Then, the release lever 73 connected to the front cover 63 is guided by the guide projection 87 of the right side plate 61R and moved forward. As a result, the rear edge of the through-hole 121 of the release lever 73 is in contact with the inclined side surface 103d of the engagement portion 103 of the lock lever 91 protruding from the through-hole 121. As a result, the engagement portion 103 is pushed outward, and the lock lever 91 starts to move rightward against the biasing force of the coil spring 95.

As the release lever 73 is further moved forward, as shown in FIG. 12B, the top surface 103a of the engagement portion 103 of the lock lever 91 is pushed in by the outer surface of the release lever 73. As described above, the lock member 71 is moved from the lock position to the unlock position, and the engagement portion 103 is separated from the engagement opening 35a of all the developing devices 35. Thereafter, by lifting up the developing devices 35, all the developing devices 35 can be detached from the frame 31.

As described above, all the developing devices 35 can be unlocked to the frame 31 by only opening the front cover 63.

While the present disclosure has been described with respect to specific embodiments, the present disclosure is not limited to the above embodiments. Those skilled in the art may modify the above embodiments without departing from the scope and spirit of the present disclosure.

1. An image forming apparatus comprising:
a process unit which is pulled out from an apparatus main body along a predetermined pull-out direction, wherein
the process unit includes:
a pair of side plates which face each other in a left-and-right direction crossing the pull-out direction;
a plurality of developing devices which are arranged side by side along the pull-out direction and attached to the side plates detachably;
a lock member which is provided for each of the developing devices and movable along the left-and-right direction between a lock position protruding into the apparatus main body through the side plate and an unlock position separating from the side plate to an outside of the apparatus main body; and
a biasing member which biases the lock member to the lock position, and
the apparatus main body includes a guide part which is provided so as to protrude to a direction far from the developing device in the left-and-right direction and guides one of the lock members from the lock position to the unlock position with a pull-out operation of the process unit, and
as the process unit is pulled out, one of the lock members is guided by the guide part and moved to the lock position or the unlock position such that the developing device corresponding to the lock member is locked or unlocked to the side plate.

2. The image forming apparatus according to claim 1, wherein
when the process unit is pulled out from the apparatus main body, one of the lock members is guided by the guide part to be moved from the lock position to the unlock position, the developing device engaged with the lock member is unlocked to the side plate,
in a state where one of the lock members is moved to the unlock position, the developing device corresponding to the lock member is housed between the side plates, then the process unit is pulled out along the pull-out direction until the lock member is separated from the guide part, and then the lock member is biased by the biasing member from the unlock position to the lock position so that the developing device is locked to the side plate.

3. The image forming apparatus according to claim 1, wherein
the lock member includes:
a cap, and
an engagement portion which is provided integrally with the cap and engageable with the developing device,
the apparatus main body includes a groove along which the lock member is guided along the pull-out direction,
the guide part includes upper and lower guide pieces disposed above and below the groove and protruding in the direction far from the developing device in the left-and-right direction, and
one of the lock members reaches the guide part when the process unit is pulled out from the apparatus main body, the cap is guided by the upper and lower guide pieces to be moved in the direction far from the developing device, and then the engagement portion is separated from the developing device.

4. The image forming apparatus according to claim 3, wherein
the pull-out direction is along a front-and-rear direction,
the engagement portion has a pair of inclined surfaces tapered in the left-and-right direction viewed from the upper-and-lower direction,
the process unit includes a release lever which is supported movably in the pull-out direction and has a through-hole through which the engagement portion is penetrated, and,
by moving the release lever, the inclined surface of the engagement portion is pushed by an edge portion of the through-hole to move the lock member from the lock position to the unlock position against a biasing force of the biasing member so that the engagement portion is separated from the developing device.
